(19) United States
(12) Patent Application Publication
(10) Pub. No.: US 2008/0318556 A1
(43) Pub. Date: Dec. 25, 2008

(54) IP BASED LAWFUL INTERCEPTION ON LEGACY EQUIPMENT

(75) Inventors: Neset Arda Erol, Vancouver (CA); Ronald McLeod, Richmond (CA)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC., Alameda, CA (US)

(21) Appl. No.: 11/765,879

(22) Filed: Jun. 20, 2007

(51) Int. Cl. H04Q 7/34

(52) U.S. Cl. 455/414.1

(57) ABSTRACT

A system and method for lawful intercept of call content receives subscriber information as a lawful intercept target and issues commands to initiate bridge endpoints in a lawful intercept media router (LIR) for transmitting RTP data. The LIR receives the bridge endpoint commands and provides duplicates of RTP data packets associated with the subscriber transmitted through the endpoint for transmission to a delivery function.

### REFERENCE TO RELATED APPLICATIONS

This application is related to co-pending U.S. patent application Ser. No. 11/683,619 filed on Mar. 8, 2007 entitled IP BASED LAWFUL INTERCEPTION AT THE SOURCE having a common assignee with the present application.

### BACKGROUND OF THE INVENTION

1. Field of the Invention

This invention relates generally to the field of interception of electronic transmission by law enforcement agencies and, more particularly, to a system an method for lawful interception of the contents of mobile telephone calls through the use of a lawful intercept media router for media duplication of call content in the RTP stream and forwarding to a delivery function.

2. Description of the Related Art

Law enforcement agencies (LEA) may obtain court orders for monitoring or intercepting electronic communications of certain individuals or organizations. This procedure, classically called “wire tapping” has regularly been employed with public switched telephone networks through physical switching arrangements. The development and use of wireless communication devices, primarily mobile or cellular phones has created additional technical complexity in carrying out such lawful interception of communications.

Standards for systems configured to allow lawfully authorized interception have been developed by the Telecommunications Industry Association (see ANSI J-STD25A “Lawfully Authorized Electronic Surveillance”). Systems meeting this standard and both industry and law enforcement agency needs and required must be capable of identifying communications of an intercept subject or target and provide information to be intercepted for both call content and call identifying information. Further, to be effective, such systems must operate covertly to preclude knowledge by the intercept subject of the interception. Systems implemented by telecommunication providers nominally must provide an access function for the call content and call identifying information and a delivery function for delivering that information to a LEA system for collection and processing. Most current intercept approaches involve the addition of an additional server or other data processing system through which all call data passes to allow selection and retention of the desired information for a target. This approach requires significant additional system complexity and often inserts delays in the system that affects call quality of service.

It is therefore desirable to provide a system and method which seamlessly provides call identifying information and content without adding unnecessary complexity to the system as a whole and which operates in a manner that is undetectable by the intercept subject or the parties communicating with the subject.

In an all-IP telephony network, Lawful Interception (LI) of call-content cannot be carried out using traditional (e.g. TDM-based or ATM-based) technologies. Instead of adding TDM and/or ATM-based LI equipment to the network, therefore, it is desirable to perform LI at the Real Time Transport Protocol (RTP) level. However in legacy equipment the capability to perform at this level may not be available. It is therefore desirable when Lawful Interception is enabled on a call, any related media steams that are generated or consumed by legacy equipment is rerouted to go through an LI Media Router (LIR). The role of the Media Router in the network is to create duplicate copies of any RTP packets that go through it and to forward these packets to one or more Delivery Functions (DF).

### SUMMARY OF THE INVENTION

The present invention provides a system and method for lawful interception of call content, for receiving subscriber information as a lawful intercept target, and issuing a command to initiate a bridge endpoint in a lawful intercept media router (LIR) for transmitting RTP data. The LIR receives the bridge endpoint request and provides duplicates of RTP data packets associated with the subscriber transmitted through the endpoint for transmission to a delivery function.

In an exemplary embodiment, the system also issues a request to initiate a second bridge endpoint in a lawful intercept media router (LIR) for transmitting RTP data. The LIR receives the second bridge endpoint request and provides duplicates of RTP data packets associated with the subscriber transmitted through the second endpoint for transmission to a delivery function.

For the endpoints established by the LIR of the inventive system bridge, the endpoint requests include definition of IP addresses and UDP port numbers for at least one delivery function. The bridge endpoint request comprises an attribute in a remote SDP and the acknowledgement is a local SDP having a identical subset of the attributes in the remote SDP.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of an exemplary legacy media gateway communications system operable with an embodiment of the present invention without lawful intercept authorization;

FIG. 2 is a block diagram of the media gateway and elements of the present invention with lawful intercept authorized;

FIG. 3 is a flow diagram of the interaction of elements in the system of FIG. 1 with normal call flow; and,

FIG. 4 is a flow diagram of the interaction of elements in the system of FIG. 2 for media forking according to the present invention with LI enabled.

### DETAILED DESCRIPTION OF THE INVENTION

Many media devices, such as media gateways (MGW), do not support Lawful Interception of call content. In order to support Lawful Interception in the presence of these devices, embodiments of the present invention provide an external device enabling interception. Each MGW is associated with a Lawful Intercept Media Router (LIR) through a MGW attribute. Multiple MGWs may be associated with the same LIR.

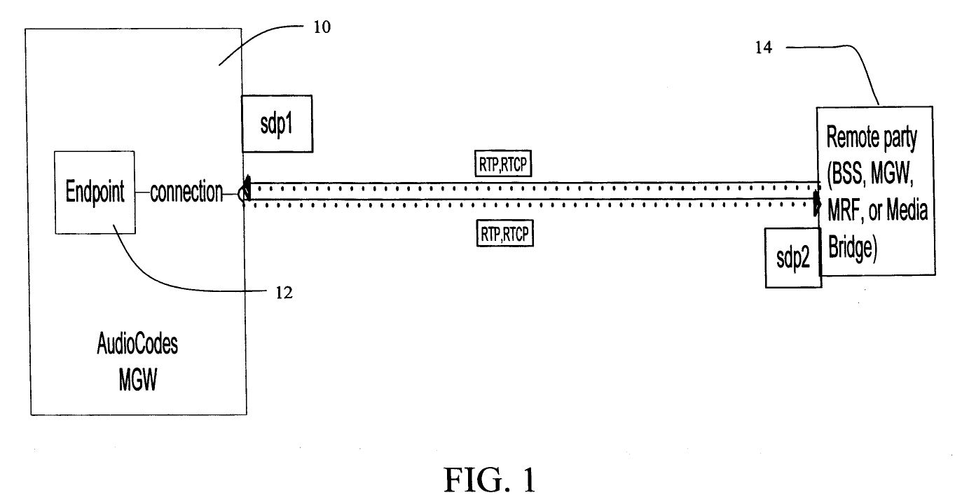

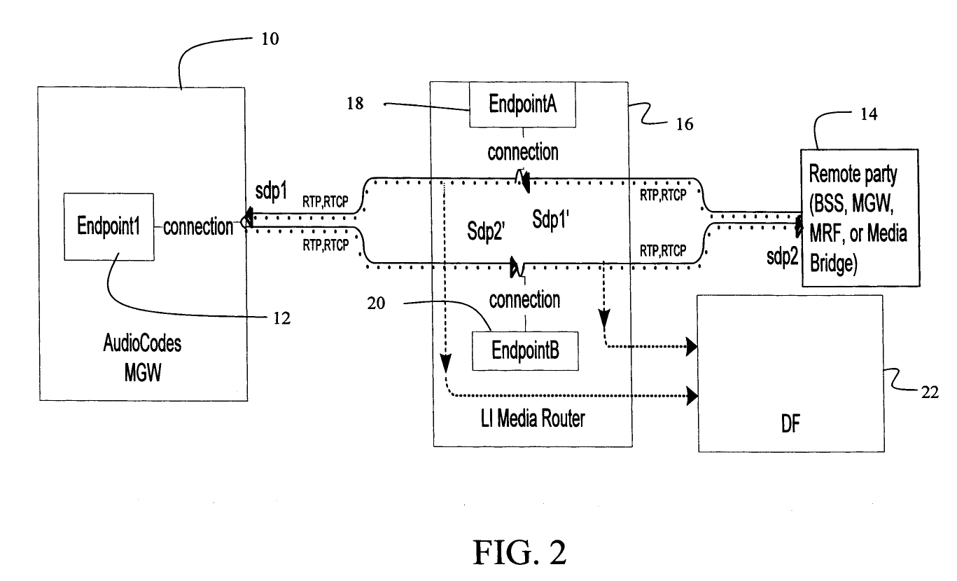

As shown in FIGS. 1 and 2, for the MGW in normal operation without authorized lawful interception, MGW 10 communicates from its endpoint 12 via RTP/RTCP to a remote party 14 which may be a BSS, MGW, MRF, or Media Bridge. When lawful interception is authorized as shown in FIG. 2, LIR 16 implements “bridge” endpoints 18, 20 that simply relays any RTP and RTCP packets they receive back out. Each endpoint is used to form a unidirectional bridge between a source device and destination device. As an alternative to a relay-endpoint with one connection, a conference-endpoint is implemented in alternative embodiments with two connections (i.e. a non-mixed 2-way conference). In this case each pair of relay-endpoints would be replaced by a single 2-way conference-endpoint.

In addition to its RTP/RTCP bridging capability, the LIR creates any desired number of additional forks of the RTP stream that is routed by a relay-endpoint. In this case, an additional copy of every received RTP packet is sent to each Lawful Interception Delivery Function (DF) destination. These additional forks are an attribute of the main bridging connection; i.e. they do not constitute additional MGCP connections. RTCP packets are routed but not forked to DF destinations.

The duplicate copies of these packets are then sent to one or more DFs 22. The content and destination of the original copies of the packets is not altered in any way, so lawful interception has no impact on the original media streams.

The LIR for the embodiments disclosed herein supports Media Gateway Control Protocol (MGCP) for control. At a minimum it must support the CRCX, MDCX, and DLCX commands and must support automatic replies to heartbeat messages generated by the Mobile Switching Center (MSC), which controls the call functions.

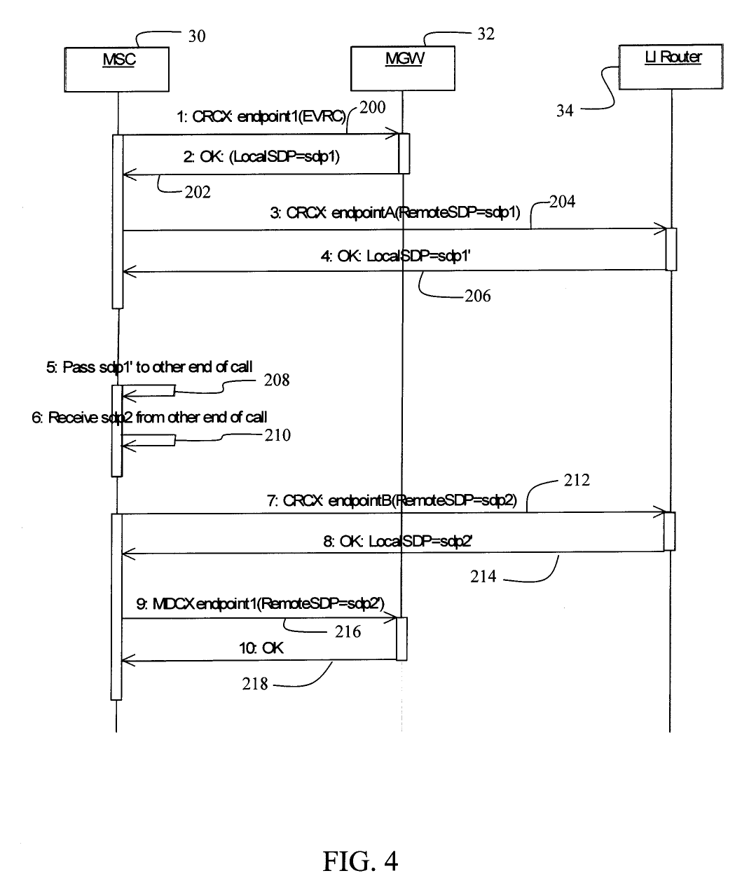

For the LIR endpoints as shown in FIG. 2 and as described in greater detail with respect to FIG. 4, endpoint names are dynamically created by the MSC, i.e. the MGCP client. The LIR accepts any name provided by the MSC and uses it to create a virtual relay-endpoint with that name. For the embodiments disclosed herein, each endpoint name must be unique for the duration of its existence. Endpoint names are in the following format:

networkinterfacename-xxxxx@mscaddress

where networkinterfacename is the name of the interface on the LI router that is used for the connection on the endpoint, and xxxxx is any arbitrary string of characters allowed by the MGCP standard, and mscaddress indicates the IP address of the MSC that sends out the MGCP message to the LIR. The address can either be dot format IPv4 address or a resolvable domain name, e.g. “uplink0-23e5a @172.16.129.50”

Every endpoint supports one and only one connection on it. An endpoint is destroyed when its connection is deleted, hence its name can be reused for other endpoints after that point.

For the embodiment disclosed herein, the LIR ignores all MGCP media attributes and uses the codec list in the remote session description (remote SDP) instead to determine the full set of codecs. Based on this approach, the LIR does not return a Local SDP for an endpoint until it receives a Remote SDP for the endpoint. Once it receives a Remote SDP, it modifies the media related IP addresses and port numbers and returns it as the endpoint's Local SDP. The LIR is codec-invariant, i.e. its operation is identical regardless of the codec used; hence it can support any existing and future codec standards.

The LIR for the embodiment disclosed supports wildcarded DLCX messages, e.g. the MSC may issue a “DLCX*@172.16.129.50” to delete all active connections on the LIR for the exemplary address used herein.

The LIR is not required to generate an RSIP message during its startup.

For the CRCX and MDCX commands, the LIR accepts a proprietary SDP attribute that describes the LI forking destinations (i.e. the DF address/ports to use):

a=X-UTStarMFr:<li . . . destination . . . list>

The LI destination list is defined as up to 4 ip:port pairs separated by commas, i.e.:

ip:port,ip:port, . . . (0 to 4 ip:port pairs)

The destination list may be empty, in which case no LI interception is performed and the endpoint acts as a simple bridge. The colon following the attribute name must always be present even when the destination list is empty.

The LI SDP attribute is inserted into the Remote SDP whenever a CRCX or MDCX command containing a remote SDP is issued to the LIR. The following example shows the use of the media fork attribute for two media forks:

v=0

c=IN IP4 172.16.129.23

m=audio 16398 RTP/AVP 60

a=X-UTStarMFr:192.168.0.10:5000,192.168.0.10:5002

In this example, the LIR forms a bridge between the input (described by the returned local SDP) and the RTP destination 172.16.129.23 at port 16398. In addition, a copy of every received packet is sent to destinations 192.168.0.10:5000 and 192.168.0.10:5002.

The LIR responds when a remote SDP is received as follows. If multiple “X-UTStarMFr” attributes are present, they are treated as one combined list. If no “X-UTStarMFr” attribute is present, then any previous media fork setup is disabled. This is identical to providing an empty fork destination list.

Under all circumstances, a local SDP is returned to the MGCP client. The returned local SDP is identical to the remote SDP received from the MGCP client, except for the following fields.

The IP address on the c= line is replaced by the IP address of a network interface on the LIR. The name of the network interface is extracted from the name of each endpoint (described above).

The UDP port number on the m= line is replaced by a UDP port number on the LIR. The LIR manages a configurable range of UDP port numbers for each of its network interfaces.

Any “a=X-UTStarMFr:” line is removed within the local SDP.

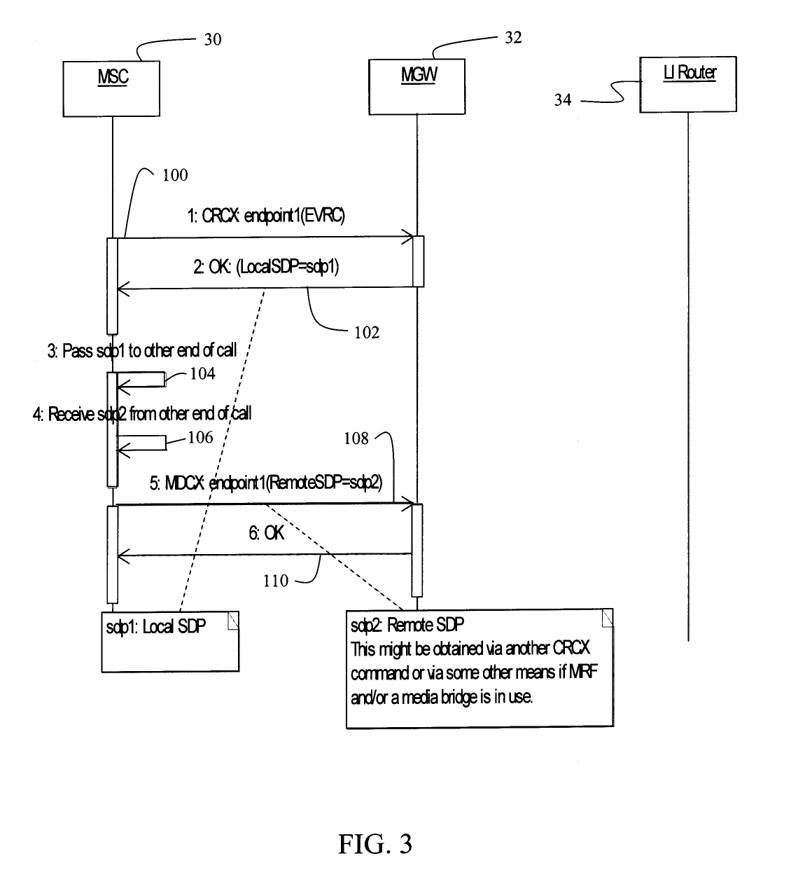

Functioning of the embodiments described herein is shown in FIGS. 3 and 4. In FIG. 3 where lawful interception is not authorized, MSC 30 initiates a session by issuing a CRCX command 100 to MGW 32 with endpoint1 (EVRC) as the endpoint for the session. The MGW responds with an OK 102 including a local SDP designated as sdp1. The MSC passes sdp1 to the other end of the session 104 and receives 106 an SDP designated sdp2 from the endpoint. The MSC provides sdp2 to the MGW with a MDCX command 108 for endpoint1 with sdp2 as the remote SDP. The MGW responds with an OK 110 and the call progresses. The remote SDP may be forwarded by the MSC in another CRCX command or via alternate means if a media bridge or Media Resource Function (MRF) is in use.

In FIG. 4 where lawful interception is authorized for endpoint1, the MSC 30 setup for a lawfully intercepted call provides via CRCX command 200 the endpoint1 (EVRC) identification to the MGW 32 with responds with an OK 202 including the local SDP designated sdp1 as for the non lawful interception case in FIG. 3. However, the MSC additionally provides a CRCX command 204 to LIR 34 for endpoint A setup with the remote SDP identified as sdp1 corresponding to the authorized lawful interception endpoint at endpoint1. The LIR responds with an OK 206 providing a local SDP identified as sdp1′ having the characteristics previously defined. The MSC passes sdp1 to the other end of the call 208 and receives 210 an SDP designated sdp2 from the endpoint. The MSC issues CRCX command 212 to the LIR for endpoint B a remote SDP identified as sdp2. The LIR responds with an OK 214 providing a local SDP identified as sdp2′ having the characteristics previously defined. The MSC provides sdp2 to the MGW with a MDCX command 216 for endpoint with sdp2 as the Remote SDP. The MGW responds with an OK 218 and the call progresses.

Media direction control remains intact even when LI is enabled. In other words, sendonly, sendrecv, and recvonly modes are controlled via the MGW (and other media devices such as the MRF) only. The LI router shall always be configured to sendrecv mode; the LI router will ignore any media direction configuration passed to it and will always assume sendrecv.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A method for lawful intercept of call content comprising the steps of:
receiving subscriber information as a lawful intercept target;
issuing a command to initiate a bridge endpoint in a lawful intercept media router (LIR) for transmitting RTP data;
receiving the bridge endpoint command in the LIR and
providing duplicates of RTP data packets associated with the subscriber transmitted through the endpoint for transmission to a delivery function.

2. A method as defined in claim 1 wherein the bridge endpoint command includes definition of IP addresses and UDP ports for at least one delivery function.

3. A method as defined in claim 1 further comprising the step of providing an acknowledgement of the bridge endpoint command from the LIR.

4. A method as defined in claim 1 wherein the bridge endpoint command comprises an attribute in a remote SDP.

5. A method as defined in claim 3 wherein the acknowledgement comprises a local SDP comprising a identical subset of the attributes in the remote SDP.

6. A method as defined in claim 4 wherein the bridge endpoint command includes an attribute having a format of: a=X-UTStarMFr:<LI . . . destination . . . list>

7. A method as defined in claim 1 further comprising the steps of:
issuing a command to initiate a second bridge endpoint in a lawful intercept media router (LIR) for transmitting RTP data;
receiving the second bridge endpoint command in the LIR and
providing duplicates of RTP data packets associated with the subscriber transmitted through the second endpoint for transmission to a delivery function.

8. A method as defined in claim 7 wherein the second bridge endpoint command includes definition of IP addresses and UDP ports for at least one delivery function.

9. A method as defined in claim 7 further comprising the step of providing an acknowledgement of the second bridge endpoint command from the LIR.

10. A method as defined in claim 7 wherein the second bridge endpoint command comprises an attribute in a remote SDP.

11. A method as defined in claim 9 wherein the acknowledgement comprises a local SDP comprising a identical subset of the attributes in the remote SDP.

12. A method as defined in claim 10 wherein the second bridge endpoint command includes an attribute having a format for a=X-UTStarMFr:<LI . . . destination . . . list>.

13. A method as defined in claim 7 wherein the media transfer element is a BSC and an MSC receives the lawful intercept target subscriber information and issues the media forking command.

14. A system for lawful intercept of call content comprising:
a control element for receiving subscriber information as a lawful intercept target, said control element having means for issuing an endpoint command for a bridge endpoint;
a lawful intercept media router (LIR) transmitting RTP data and having
means for receiving the endpoint command and
means for providing duplicates of RTP data packets associated with the subscriber transmitted through the media transfer element for transmission to a delivery function.
